(19) United States
(12) Patent Application Publication
(10) Pub. No.: US 2009/0003822 A1
(43) Pub. Date: Jan. 1, 2009

(54) HAND-HELD PHOTOGRAPHIC SUPPORT SYSTEM

(76) Inventor: Frank Tyner, Lake Havasu City, AZ (US)

Correspondence Address: WEISS & MOY PC, 4204 NORTH BROWN AVENUE, SCOTTSDALE, AZ, 85251, US

(21) Appl. No.: 11/821,817

(22) Filed: Jun. 27, 2007

(51) Int. Cl. G03B 17/00

(52) U.S. Cl. 396/428; 248/187.1

(57) ABSTRACT

A hand-held photographic support system consists of a telescoping shaft having an elongated handle at a first end, and a camera platform at a second end. A view screen is positioned on the handle. A camera positioned on the camera platform is in communication with the view screen, so that a user may view on the view screen images seen by the camera when positioned remotely from the user on the telescoping shaft in an extended positioned. In one embodiment, the system may be coupled to a second support device, such as a tripod or monopod.

### FIELD OF THE INVENTION

The present invention relates generally to photography and, more particularly, to a hand-held, telescoping, photographic support system and method that provides extended photographic views.

### BACKGROUND OF THE INVENTION

A variety of photographic support systems are known in the art. Tripods, for example, may be utilized to position a still or video camera in a fixed position, so as to improve the quality of images captured with a camera positioned thereon. Monopods may be utilized to permit a user to extend a camera above a crowd.

The present invention is directed to an improved, hand-held photographic support system that permits a user to vertically extend the reach of a camera, while still maintaining an ability to view images that are to be captured from the camera and to effectively control camera operations.

### SUMMARY OF THE INVENTION

In accordance with an embodiment of the present invention, a hand-held photographic support system is disclosed. The system comprises, in combination: an elongated handle having a first end and a second end; a view screen positioned on the elongated handle; a telescoping shaft coupled at a lower end thereof to the first end of the elongated handle; a camera platform located at an upper end of the telescoping shaft; and means for permitting communication of images viewed by a camera located on the camera platform to the view screen.

In accordance with another embodiment of the present invention, a hand-held photographic support system is disclosed. The system comprises, in combination: an elongated handle having a first end and a second end; a view screen positioned on the elongated handle; a telescoping shaft coupled at a lower end thereof to the first end of the elongated handle; a camera platform located at an upper end of the telescoping shaft, a camera located on the camera platform; and means for permitting communication of images viewed by the camera to the view screen.

In accordance with a further embodiment of the present invention, a method for capturing images from a remotely positioned camera is disclosed. The method comprises: providing an elongated handle having a first end and a second end; providing a view screen positioned on the elongated handle; providing a telescoping shaft coupled at a lower end thereof to the first end of the elongated handle; providing a camera platform located at an upper end of the telescoping shaft; positioning a camera on the camera platform, wherein the camera is in communication with the view screen so that images viewed by the camera are communicated to the view screen; extending the telescoping shaft; viewing images on the view screen; and remotely activating the camera so as to capture at least one image.

### BRIEF DESCRIPTION OF THE DRAWINGS

FIG. 1 is a perspective view showing a photographic support system consistent with an embodiment of the present invention, together with a camera mounted thereon, in use.

FIG. 2 is a side view of a photographic support system consistent with an embodiment of the present invention, with a camera mounted thereon and with the view screen in a tilted configuration.

FIG. 3 is a front view of a handle portion of a photographic support system consistent with an embodiment of the present invention.

FIG. 4 is a front view of a camera located on, and in wired communication with, a photographic support system consistent with an embodiment of the present invention.

FIG. 5 is a side view of a photographic support system consistent with an embodiment of the present invention, mounted to a tripod, and with a video type camera mounted thereon.

FIG. 6 is a side view of a photographic support system consistent with an embodiment of the present invention, mounted to a monopod.

FIG. 7 is a perspective view showing a photographic support system consistent with an embodiment of the present invention, together with a camera mounted thereon.

### DETAILED DESCRIPTION OF THE PREFERRED EMBODIMENTS

Referring first to FIGS. 1-2, elements of a photographic support system 10 (“system 10”) consistent with an embodiment of the present invention. In this embodiment, the system 10 comprises an elongated handle 12, a view screen 14 located at an upper portion of the handle 12, a telescoping shaft 16 coupled at a lower end thereof to the handle 12, and a camera platform 18 located at an upper end of the telescoping shaft 16. The camera platform 18 may be tiltable and/or rotatable relative to the telescoping shaft 16, and is adapted to receive a camera 20 thereon. The camera 20 may be a still or video camera.

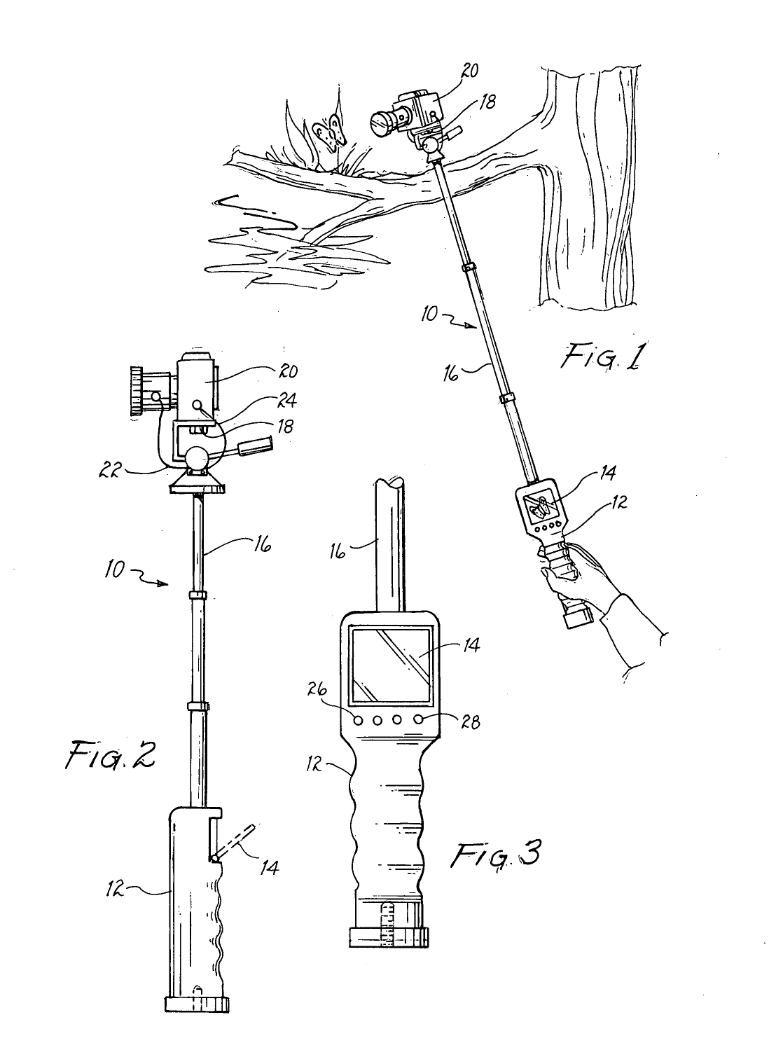

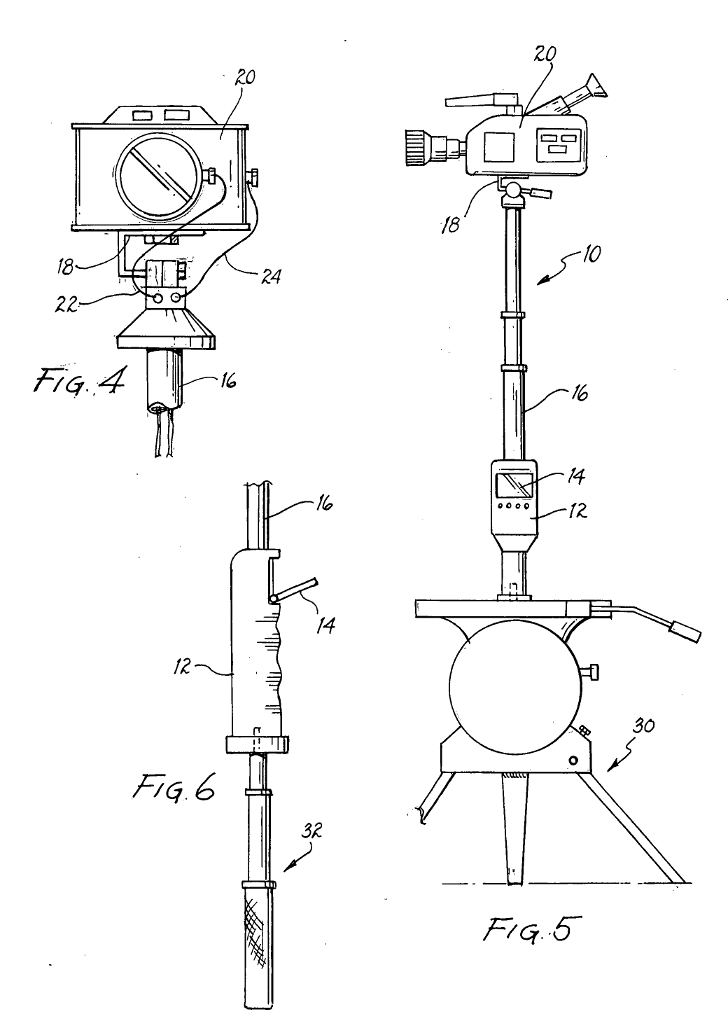

Referring now to FIGS. 2-4, a user may be provided with the ability to control the camera 20 from the handle 12. In one embodiment, this may be accomplished by providing a cable connection between the system 10 and the camera 20, so that a user may control shutter release, focus, on-off, and perhaps other actions from the handle 12. For example, a first cable 22 may be utilized to transmit images from the camera 20 to the view screen 14. A second cable 24 may be utilized to permit remote shutter control from handle 12 by, for example, depressing button 26. On/off control may be communicated via first cable 22, second cable 24, or otherwise to the handle 12, where it may be activated by depressing button 28. Other controls, such as focus, flash, shutter speed, etc., may also be made controllable from the handle 12.

More than two cables may be provided or, optionally, all desired controls may be routed through a single cable. Still further, it may be desired to provide wireless communication between the handle 12 (including view screen 14) and the camera 20.

The view screen 14 may be of the LCD type. It is intended to permit a user to view the same images that a viewer would see if looking through the viewfinder of the camera 20 in a hand-held configuration. As best seen in FIG. 1, a user who positions a camera 20 on the system 10 and extends it several feet into the air will be able to view, via view screen 14, the images that may be captured by the lens of camera 20. This provides improved accuracy, and limits the wasting of film, memory, battery life, etc.

Referring to FIGS. 5-6, in one embodiment, the system 10 may be coupled to a second support device, such as a tripod 30 or a monopod 32. Such coupling may be by any desired means, including for example by providing a threaded female opening at the base of the handle 12, into which a mating male threaded shaft on the trip 30 or monopod 32 may be inserted and secured.

Where the handle 12 is held in a raised position, or positioned in a raised position utilizing a tripod 30 or monopod 32, it may be difficult for the user to see the view screen 14. For such uses, and referring now to FIGS. 2 and 6, it may be desired to provide a view screen 14 that is tiltably coupled to the handle 12, so that the view screen 14 may be tilted downward to permit a user positioned therebelow to more effectively see images thereon.

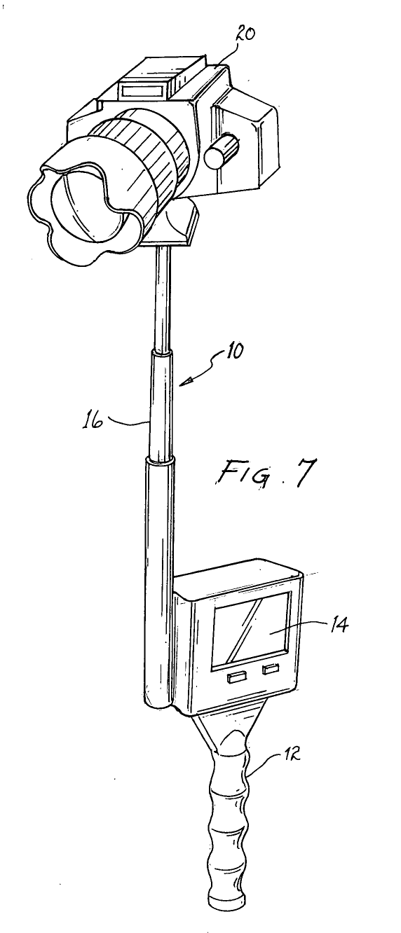

Referring now to FIG. 7, another embodiment of a system 10 is presented. In this embodiment, the telescoping shaft 16 is coupled at an offset from the view screen 14, instead of being positioned substantially directly above it as shown in FIGS. 1-6. This configuration may provide, for some users, a more stable support for the camera 20 when the system 10 is in use.

Although particular embodiments of the invention have been described in detail for purposes of illustration, various modifications may be made without departing from the spirit and scope of the invention. Accordingly, the invention is not to be limited, except as by the appended claims.

1. A hand-held, photographic support system comprising, in combination:
an elongated handle having a first end and a second end;
a view screen positioned on the elongated handle;
a telescoping shaft coupled at a lower end thereof to the first end of the elongated handle;
a camera platform located at an upper end of the telescoping shaft; and
means for permitting communication of images viewed by a camera located on the camera platform to the view screen; and
a second support device removably coupled to the second end of the elongated handle.

2. The system of claim 1 wherein the view screen is tiltably coupled to the elongated handle.

3. The system of claim 1 wherein the camera platform is tiltable.

4. The system of claim 1 wherein the telescoping shaft is offset relative to the elongated handle.

5. The system of claim 1 wherein the second support device is a tripod.

6. The system of claim 1 wherein the second support device is a monopod.

7. The system of claim 1 wherein the means for permitting communication of images viewed by the camera comprises a cable coupling.

8. A hand-held, photographic support system comprising, in combination:
an elongated handle having a first end and a second end;
a view screen positioned on the elongated handle;
a telescoping shaft coupled at a lower end thereof to the first end of the elongated handle;
a camera platform located at an upper end of the telescoping shaft;
a camera located on the camera platform;
means for permitting communication of images viewed by the camera to the view screen; and
a second support device removably coupled to the second end of the elongated handle.

9. The system of claim 8 wherein the view screen is tiltably coupled to the elongated handle.

10. The system of claim 8 wherein the camera platform is tiltable.

11. The system of claim 8 wherein the telescoping shaft is offset relative to the elongated handle

12. The system of claim 8 wherein the second support device is a tripod.

13. The system of claim 8 wherein the second support device is a monopod.

14. The system of claim 8 wherein the means for permitting communication of images viewed by the camera comprises a cable coupling.

15. The system of claim 8 wherein the camera is a still camera.

16. The system of claim 8 wherein the camera is a video camera.

17. A method for capturing images from a remotely positioned camera comprising:
providing an elongated handle having a first end and a second end;
providing a view screen positioned on the elongated handle;
providing a telescoping shaft coupled at a lower end thereof to the first end of the elongated handle;
providing a second support device;
coupling the second support device to the second end of the elongated handle;
providing a camera platform located at an upper end of the telescoping shaft;
positioning a camera on the camera platform, wherein the camera is in communication with the view screen so that images viewed by the camera are communicated to the view screen;
extending the telescoping shaft;
viewing images on the view screen;
remotely activating the camera so as to capture at least one image; and
removing the second support device from the second end of the elongated handle.

18. The method of claim 17 wherein the telescoping shaft is offset relative to the elongated handle.

19. The method of claim 17 wherein the second support device is a tripod.

20. The method of claim 17 wherein the second support device is a monopod.
